(19) United States
(12) Patent Application Publication
(10) Pub. No.: US 2012/0167398 A1
(43) Pub. Date: Jul. 5, 2012

(54) Secateurs for Fruit Picking

(76) Inventors: Jose Ramon MANZANA BOIX, Castellon (ES); Raul MANZANA BOIX, Castellon (ES)

(21) Appl. No.: 13/103,222

(22) Filed: May 9, 2011

(30) Foreign Application Priority Data
Dec. 30, 2010 (ES) U201031328

(51) Int. Cl. A01G 3/02

(52) U.S. Cl. 30/261

(57) ABSTRACT

Secateurs for picking fruit that have two arms assembled in a pivoting manner that move against each other around a pivoting axis and against the action of an elastic spring, each arm having a gripping area and a cutting area, and the cutting area of each one of the arms has a portion with an appreciably concave curved shape with a sharpened edge, so that in the situation of the maximum approach of one to the other of the two cutting areas, both appreciably concave curved portions form an open concave curved housing; and there being a difference in height of one sharpened edge against the other, in such a way that during the movement of both arms coming together in the cutting action, the sharpened edge of one of the arms is superimposed over the sharpened edge of the other arm.

### CROSS REFERENCE TO RELATED APPLICATIONS

This application claims priority of ES Application No. 0201031328 filed Dec. 30, 2010, which is incorporated by reference herein in its entirety.

### DESCRIPTIVE MEMORANDUM

### Object of the Invention

The present invention refers to secateurs for fruit picking that have appreciable innovations and advantages when compared to the present known state of the art.

More specifically, the invention relates to secateurs for fruit picking, especially for citrus fruit, in particular the type that has two arms that are assembled in a pivoting manner in which one moves against the other around a pivoting axis and against the action of an elastic spring, each arm having a gripping area and a cutting area that improves the cutting operation of the stalk.

### BACKGROUND TO THE INVENTION

It is well known that in the fruit picking, such as citrus fruits, one known technique is that which is carried out in a manual way by means of using secateurs or shears, in such a way that the picker separates the fruit from the tree by cutting the stalk.

Secateurs known for the previously described purpose are those which are made up of two arms that pivot around each other, one of which has a sharpened and cutting area which abuts a section of straight wall located on the opposite arm.

However, in practice it has been proven that this arrangement of the cutting area of the secateurs reduces the picking productivity on slowing down the cutting action of the secateurs on the stalk of the citrus plant as it has to repeat the cutting action at least twice so as to cut the same stalk and on having to change the cutting tool and bringing about bad cuts of the stalk due to the fast wear suffered by the sharpened edge on coming up against the stop with every one of the stalk cutting operations.

In addition, the applicant is not aware of the existence of any secateurs that have all of the characteristics that are described in this memorandum.

### DESCRIPTION OF THE INVENTION

The present invention has been developed for the purpose of providing secateurs aimed at solving the previously stated disadvantages, in addition giving other advantages that will be evident from the description that is attached below.

It is therefore an object of the present invention to provide secateurs for fruit picking that have two arms assembled in a pivoting manner that move against each other around a pivoting axis and against the action of an elastic spring, each arm having a gripping area and a cutting area, and which is basically characterised in that the cutting area of each one of the arms has a portion with an appreciably concave curved shape with a sharpened edge, so that in the situation of the maximum approach of one to the other of the two cutting areas, both appreciably concave curved portions form an open concave curved housing; and there being a difference in height of one sharpened edge against the other, in such a way that during the movement of both arms coming together in the cutting action, the sharpened edge of one of the arms is superimposed over the sharpened edge of the other arm.

Thanks to the above described arrangement of the cutting area the productivity is increased during the manual fruit picking as it appreciably reduces the wear of the cutting areas of the tool. Another no less important advantage is the fact that it makes a better cut of the stalk of the citrus tree during the removal of the citrus fruit as the lower curved area of the cutting areas of both arms become adapted to the contracted area in which the stalk is found.

In a preferred embodiment, one of the cutting areas includes an embossing on its lower face that acts in such a way as to prevent the cutting area from coming into contact with the peel or the surface of the fruit, preventing consequent damages on the same.

Other characteristics and advantages of the secateurs object of this present invention will become clear from a description of a non exclusive preferred embodiment, shown as a non limitative example in the annexed drawings.

### BRIEF DESCRIPTION OF THE DRAWINGS

FIG. 1.—It is a perspective view of an embodiment of the secateurs according to the present invention;

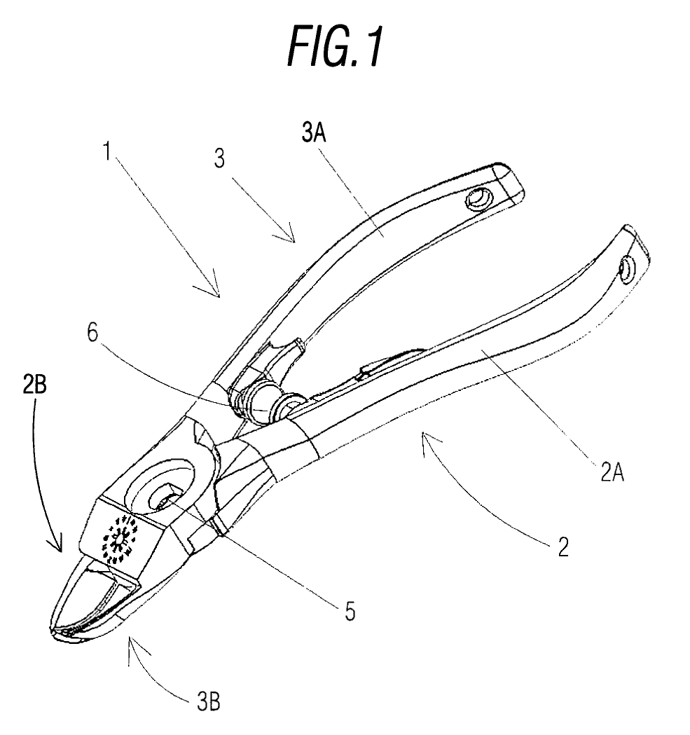

FIG. 2.—It is a detailed view of the cutting area of the arms;

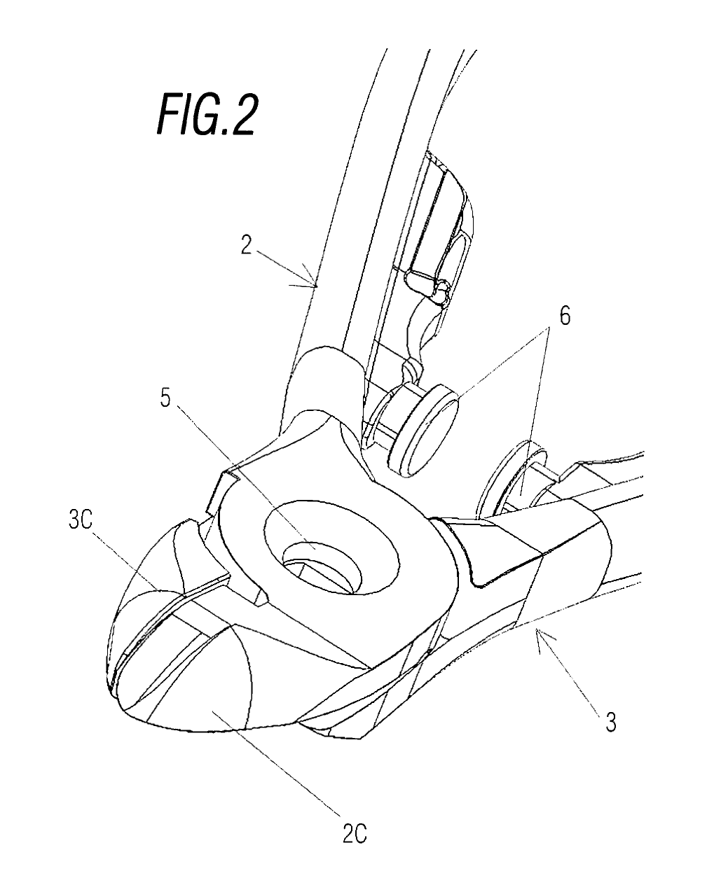

FIG. 3.—It is a perspective view corresponding to an arm of the secateurs; and

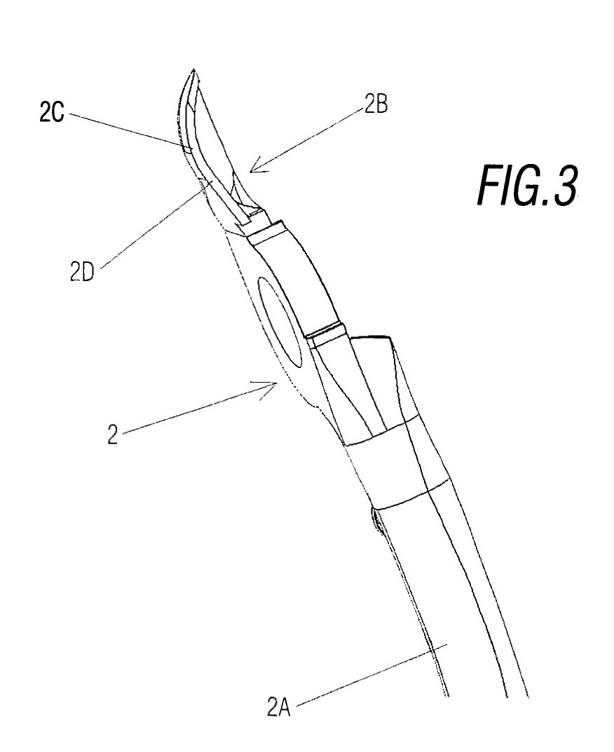

FIG. 4.—It is a perspective view from below corresponding to the other arm of the secateurs that includes an embossing.

### A DESCRIPTION OF A PREFERRED EMBODIMENT

As shown in the attached figures, one embodiment of the secateurs for the picking of citrus fruit according to the invention and stated in a general way with reference 1, basically comprises a pair of metallic arms 2, 3 assembled in a pivoting way that move against each other around a pivoting axis, in particular a bolt (not shown) that goes through an opening 5, and against the action of an elastic spring, each arm 2, 3 having a gripping area 2A, 3A with a curved shape that make the handling of the tool easier and a cutting area 2B, 3B located at the opposite end of the stated gripping area.

In particular, the cutting area 2B, 3B of each one of the arms 2, 3 has a section 2C, 3C with an appreciably concave curved shape with a sharpened edge 2D, 3D, so that, once both cutting areas come into contract with each other to make the cut of the stalk, both appreciably concave curved portions make an upper open concave curved housing that has a spoon shaped appearance. Both cutting areas 2B, 3B are made in such a way that during the movement where both arms 2, 3 are coming together in the cutting action, the sharpened edge of one of the arms is superimposed over the sharpened edge of the other arm. This overlap is determined by the existence of a difference in height of one sharpened edge compared to the other sharpened edge.

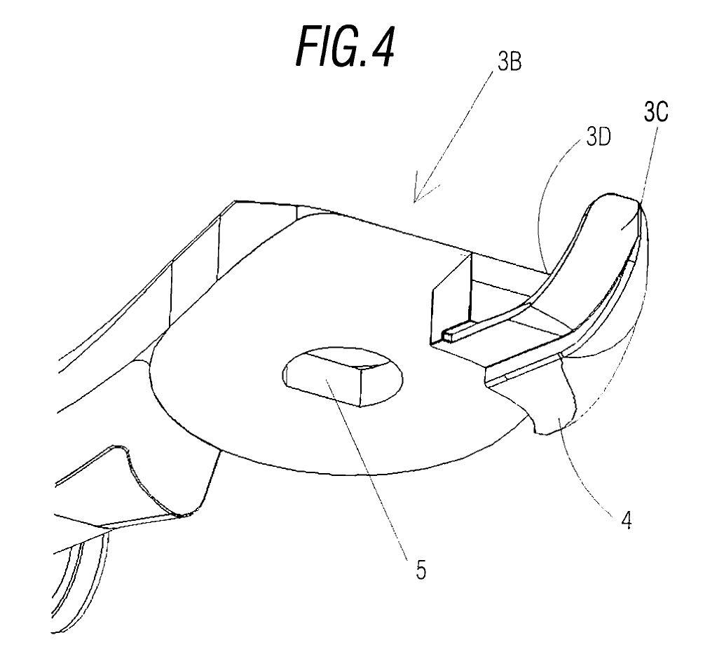

As can be seen with greater clarity in FIG. 4, an embossing 4 can be seen in the cutting area 3B that has a stepped shape, which during the stalk cutting operation stops the opposing cutting area from forming a stop with the transverse wall corresponding to the stepped section as said section works only to prevent the cutting area from making contact with the peel or surface of the fruit and bringing about damage.

By preference, the elastic spring (not shown) is fixed at its ends to protrusions 6 fitted in the gripping area of each one of the arms 2, 3.

In addition, the secateurs 1 are also provided with a blocking device (not shown) that allows the relative movement of the arms to be blocked or unblocked in a quick and simple manner, where the blocking element, which can be made from a metallic ring, is joined in a folding manner to one of the arms whilst the other arm has a coupling point so as to fix it in a removable manner.

The details, shapes, sizes and other accessorial elements, likewise the materials used in the manufacture of the secateurs of the invention can be appropriately substituted by others that are technically equivalent and do not stray away from the essentiality of the invention or the scope defined by the claims that are included below.

1. Secateurs for fruit picking comprising two arms assembled in a pivoting manner that move against each other around a pivoting axis and against the action of an elastic spring, each arm having a gripping area and a cutting area, wherein the cutting area of each one of the arms has a portion with an appreciably concave curved shape with a sharpened edge, so that in the situation of the maximum approach of one to the other of the two cutting areas, both appreciably concave curved portions form an open concave curved housing; and there being a difference in height of one sharpened edge against the other, in such a way that during the movement of both arms coming together in the cutting action, the sharpened edge of one of the arms is superimposed over the sharpened edge of the other arm.

2. Secateurs for picking fruit according to claim 1, wherein one of the cutting areas includes an embossing on its lower face with a noticeable stepped shape.

3. Secateurs for picking fruit according to claim 1, wherein the elastic spring are fixed at its ends to protrusions provided in the gripping area of each one of the arms.

4. Secateurs for picking fruit according to claim 1, wherein there is a blocking element provided for the relative movement between the two arms, the blocking element being fixed in a folding manner into one of the arms while in the opposite arm has a coupling point.
